(19) United States
(12) Patent Application Publication
(10) Pub. No.: US 2026/0251184 A1
(43) Pub. Date: Aug. 27, 2026

(54) COUNTERTRACK JOINT

(71) Applicant: GKN Driveline International GmbH, Lohmar (DE)

(72) Inventors: Stephan Maucher, Lohmar (DE); Ida Benner, Lohmar (DE); Thomas Weckerling, Lohmar (DE); Rolf Cremerius, Lohmar (DE); Hans-Jürgen Post, Lohmar (DE); Anna Gremmelmaier, Lohmar (DE)

(21) Appl. No.: 18/872,532

(22) PCT Filed: Jun. 10, 2022
(86) PCT No.: PCT/EP2022/065881

§ 371 Date: Dec. 6, 2024

(51) Int. Cl. F16D 3/2233; F16D 3/223

(52) U.S. Cl. CPC F16D 3/2233; F16D 2003/22306

(57) ABSTRACT

A countertrack joint includes an outer joint part, an inner joint part, wherein first pairs of tracks widen towards the opening side of the outer joint part when the countertrack joint is aligned, and second pairs of tracks widen towards the connection side of the outer joint part when the countertrack joint is aligned, a ball in each of the first and second pairs of tracks, and a ball cage with circumferentially distributed cage windows, each receiving one of the balls. A second outer track baseline of the outer joint part extends, starting from the joint centre plane in the direction of the joint base at least starting from a track articulation angle of +20° radially within a second outer reference arc defined by a second outer radius forming the second outer track baseline in the second offset plane.

### TECHNICAL FIELD

The disclosure relates to a constant velocity joint in the form of a countertrack joint.

### BACKGROUND

From DE 100 60 120 A1, a countertrack joint is known with an outer joint part with curved outer tracks, an inner joint part with curved inner tracks, balls which are received in the outer tracks and inner tracks, and a ball cage with cage windows in which the balls are held. First outer tracks and first inner tracks form first pairs of tracks, the first control angles of which open in a first axial direction and in which first balls are held. Second outer tracks and second inner tracks form second pairs of tracks, the second control angles of which open in a second axial direction and in which second balls are held. The outer joint part and the inner joint part are axially displaceable relative to each other.

WO 2013/029655 A1 discloses another countertrack joint. First pairs of tracks open towards the opening side when the joint is aligned, and second pairs of tracks open towards the connection side. The control angle of the pairs of tracks is greater than the control angle of the second pairs of tracks. The first centre line of the first pairs of tracks in the outer joint part runs radially inside a reference arc in the direction of the connection side and radially outside in the direction of the opening side.

DE 103 37 612 A1, a countertrack joint is known in which the track pairs opening towards the base are designed such that the opening angle, upon articulation of the joint, at a ball entering the outer joint part beyond the centre plane, initially becomes zero and then opens towards the opening side.

US 2007/0111806 A1, corresponding to WO 2006/048032 A1, discloses a further countertrack joint. The ball tracks, which open in the joint centre plane towards the connection side when the joint is aligned, have a first curved section with a small radius on the connection side, a second curved section with a larger radius in the region of the joint centre plane and a third curved section on the opening side, which has an opposite direction of curvature to the second curved section.

From DE 103 04 156 A1, a countertrack joint is known with eight balls, in which the second outer ball tracks have mounting extensions at an opening in the outer joint part for inserting second balls from radially outside into the cage windows. The second balls are inserted when the first cage windows are already fully assembled with first balls. The joint is over-articulated for insertion, wherein the second cage windows move out of the outer joint part.

WO 2007079762 A1 discloses a countertrack joint for large articulation angles.

It is an object of at least some implementations of the present disclosure to propose a constant velocity joint, which may be for small articulation angles, which has a low weight and/or high efficiency and which can be produced at low cost in order to contribute to an overall reduction in CO2.

### SUMMARY

In accordance with the disclosure, a constant velocity joint in the form of a countertrack joint is proposed. Further possible embodiments are described in the subclaims.

The inner joint part is angularly movable in relation to the outer joint part over a primary joint articulation angle range and an adjoining secondary joint articulation angle range. The primary joint articulation angle range defines the articulation angle range within which the first and second balls move along when the joint is in operation. In this respect, the primary joint articulation angle can also be referred to as the operating articulation angle. The maximum primary joint articulation angle is defined as the articulation angle at which all balls are still just participating in torque transmission between the outer joint part and the inner joint part before a first and/or second ball travelling to the opening side exits the associated track pair on the opening side. When the joint is articulated within the operating articulation angle range, the first and second balls move in respective track articulation angle ranges up to a maximum primary track articulation angle. The maximum primary joint articulation angle can may be less than +30°, i.e. during operation the inner joint part can be articulated relative to the outer joint part by a maximum of this amount. During operation, the second balls move within a primary track articulation angle range along the primary track section of the outer joint part up to a maximum primary track articulation angle. The maximum primary track articulation angle may be less than +20°, or less than ±15° around the joint centre plane.

The primary track articulation angle of the second outer ball tracks is followed by the secondary track articulation angle range in the direction towards the joint base. The first and/or second balls only move into the secondary track articulation angle range during assembly, when the joint is over-articulated. In this respect, the secondary joint articulation angle can also be referred to as the mounting articulation angle.

The track baselines of the first outer ball tracks have a largest radial first distance to the longitudinal axis within the operating articulation angle in a first offset plane (EA) parallel to the joint centre plane (EM). The track baselines of the second outer ball tracks have a largest radial second distance to the longitudinal axis within the operating articulation angle in a second offset plane (EB) parallel to the joint centre plane (EM). An offset plane intersection point (PEB) is defined between the second offset plane on the base side and the second outer track baseline (G22B). A reference circle arc (CRB12) of the second outer ball tracks is defined by the track radius which formed by the second outer track baseline (G22B) in the second offset plane (EB). It is provided that the second outer track baseline (G22B), from the joint centre plane (EM) in direction of the joint base, runs radially within the second outer reference arc (CRB12) when the joint is articulated at least starting from a track articulation angle of +15°.

An advantage of the countertrack joint is that it may be suitable for applications with small operating articulation angles. Due to the design of the second ball tracks of the outer joint part such that their track baselines run radially within the outer reference arc on the base side from a track articulation angle of ±15°, the associated ball moves radially inwards with greater curvature when the joint is over-articulated. This provides a small-angle countertrack joint with a special assembly feature. Overall, the outer joint part enables a short axial length, which leads to material savings and a low weight. The joint is therefore highly efficient, can be manufactured cost-effectively and contributes to an overall reduction in CO2 emissions.

According to an embodiment, the inner face of the outer joint part can form a support face on the connection side, against which the ball cage can be axially supported during assembly. For this, the spherical faces of the joint parts can be designed such that in the assembled state of the joint, in which the equator of the spherical inner face of the outer joint part and the equator of the spherical cage outer face lie in one plane, and the equator of the spherical cage inner face and the spherical outer face of the inner joint part lie in one plane, the outer radial gap in direction of the opening side is larger than in direction of the connection side. This allows the inner joint part, when a shaft is pressed thereinto, to be axially supported via the ball cage against the outer joint part, without the balls jamming in the ball tracks.

According to an embodiment, the track baselines (G22B) of the second outer ball tracks can each have a primary curvature in the primary track section and a secondary curvature in the secondary track section. The secondary curvature may be smaller than the primary curvature, as a result of which the ball tracks pull inwards radially on the base side more quickly and have a shorter axial extension. According to a possible specification, the second outer track baseline (G22B) can be formed in the primary track section by a circular arc with a primary radius (R22Bp) around a primary centre point (MBp), and in the secondary track section by a circular arc with a secondary radius (R22Bs) around a secondary centre point (MBs). The secondary radius may be smaller than the primary radius. The secondary centre point (MBs) can have a radial offset relative to the longitudinal axis (L12) of the outer joint part in the direction of the ball track and/or an axial offset relative to the joint centre plane (EM) in the direction of the joint base, and be arranged for example in the second offset plane (EB).

Starting from the second offset plane (EB), the primary track section of the second outer ball tracks has an opening-side primary track section between the second offset plane (EB) and the opening-side end. This opening-side primary track section extends over an opening-side track section angle (γB1) of less than 23° around the track section centre point (MBp). A base-side primary track section is formed between the second offset plane (EB) and the base-side end of the primary track section, which extends over a base-side track section angle (γB2) of less than 12° around the track section centre point (MBp). This configuration means that the primary track section of the second outer ball tracks is relatively short overall.

An outer secondary baseline radius (RMGs) is defined from the joint centre (M) to the track baseline (G22B) within the secondary track section of the second outer ball tracks (22B). According to an embodiment, the outer secondary baseline radius (RMGs), at least at a joint articulation angle of between +40° to +50°, which may be smaller than 1.45 times the pitch circle radius (PCRB) of the second balls when the joint is aligned, and/or smaller than 1.4 times the pitch circle radius (PCREB) in the second offset plane (EB) of the outer joint part. This contributes to a short design of the outer joint part.

The second ball tracks (23B) of the inner joint part have a second inner primary track section and, adjoining thereto on the opening side, a second inner secondary track section. During angular movements within the primary articulation angle range, the second balls move along the second inner primary track section up to the maximum primary articulation angle. For larger angular movements, i.e. from the secondary articulation angle range, the second balls move within the second inner secondary track section. According to an embodiment, the second inner ball tracks have a second inner track baseline (G23B), which is convex in the second inner primary track section, and at least partially concave and/or straight in the second inner secondary track section.

On the inner joint part, an inner secondary baseline radius (RMGs′) can be defined from the joint centre (M) to the track baseline (G23B) within the inner secondary track section. The inner secondary baseline radius (RMGs′) can be smaller than 1.45 times the pitch circle radius (PCRB) of the second balls when the joint is aligned, and/or smaller than 1.5 times the pitch circle radius (PCREB′) in the second offset plane (EB′) of the inner joint part, at least at a joint articulation angle of ±40° to ±50°.

According to a further embodiment, the primary joint articulation angle is smaller than 0.5 times the smallest second mounting articulation angle at which the second balls can be inserted into the second pairs of tracks. The smallest second mounting articulation angle can, for example, be greater than 60°.

The first outer ball tracks (22A) can form a first undercut (HA) on the opening side, and the second outer ball tracks (22B) can form a second undercut (HB) on the opening side. According to a further embodiment, the first undercut of the first ball tracks opening towards the opening side is smaller than the second undercut of the second ball tracks opening towards the connection side. For example, the second outer undercut (HB) can be larger than five times the first outer undercut (HA).

Various embodiments are conceivable with regard to the production of the countertrack joint. It is possible that the outer joint part and the inner joint part are manufactured in the process sequence of forging a blank into a preform, hardening the forged preform and, after hardening, mechanical finishing, for example by turning and/or grinding. Alternatively, it is possible that at least one of the outer ball track group and the inner ball track group is finish-worked before hardening, which can be achieved, for example, by forming, i.e. is mechanically unmachined after hardening. This includes that both the inner joint part and the outer joint part are finish-machined before hardening in terms of their shape. However, it also includes that only one of the joint parts is soft finished, while the other joint part, i.e. one of the outer ball track group and the inner ball track group, is hardened and hard finished. The hard machining can be, for example, machining by turning and/or grinding. A countertrack joint with at least one soft-machined joint part has the advantage that it can be manufactured cost-effectively due to the ball track group being finish-machined before hardening. A countertrack joint with one soft and one hard finished joint part has the advantage that due to the hardened and then hard-finished ball track group, the support surface of the outer joint part and the mating track form provide good guidance and support for the ball cage and therefore a high level of efficiency.

The number of torque-transmitting balls and correspondingly the outer and inner ball tracks may be divisible by two and is in particular eight, although other numbers such as 6 or 10 are also possible.

### BRIEF DESCRIPTION OF THE DRAWINGS

Certain embodiments are explained below with reference to the drawing figures. Herein:

FIG. 1A shows a countertrack joint in a longitudinal section through a first pair of tracks

FIG. 1B shows the countertrack joint of FIG. 1A in a longitudinal section through a second pair of tracks;

FIG. 1C shows the countertrack joint according to FIG. 1A with further geometric details;

FIG. 1D shows the countertrack joint according to FIG. 1B with further geometric details;

FIG. 2A shows the outer joint part of the countertrack joint according to FIG. 1B in a longitudinal section through the second pair of tracks with further geometric details;

FIG. 2B shows the outer joint part according to FIG. 2A with further geometric details;

FIG. 3A shows the outer joint part of the countertrack joint according to FIG. 1A in a longitudinal section through the first pair of tracks with further geometric details;

FIG. 3B shows the outer joint part of the countertrack joint according to FIG. 1B in a longitudinal section through the second pair of tracks with further geometric details;

FIG. 4A shows the inner joint part of the countertrack joint of FIGS. 1A-1D in a three-dimensional representation;

FIG. 4B shows the inner joint part of FIG. 4A in axial view;

FIG. 4C shows the inner joint part in longitudinal section through a first inner ball track according to section line 4C-4C from FIG. 4B;

FIG. 4D shows the inner joint part in longitudinal section through a second inner ball track according to section line 4D-4D from FIG. 4B;

FIG. 5A shows the ball cage of the countertrack joint of FIGS. 1A-1D in a three-dimensional representation;

FIG. 5B shows the ball cage of FIG. 5A in a cross-section;

FIG. 5C shows the ball cage in longitudinal section according to section line 5C-5C from FIG. 5B;

FIG. 5D shows the ball cage in longitudinal section according to section line 5D-5D from FIG. 5B;

FIG. 6A shows the countertrack joint of FIG. 1A-1D when mounting a first ball into a first ball track;

FIG. 6B shows the countertrack joint of FIG. 1A-1D when mounting a second ball into a second ball track; and

FIG. 6C shows the countertrack joint of FIG. 1A-1D when operating within the primary joint articulation angle.

### DETAILED DESCRIPTION

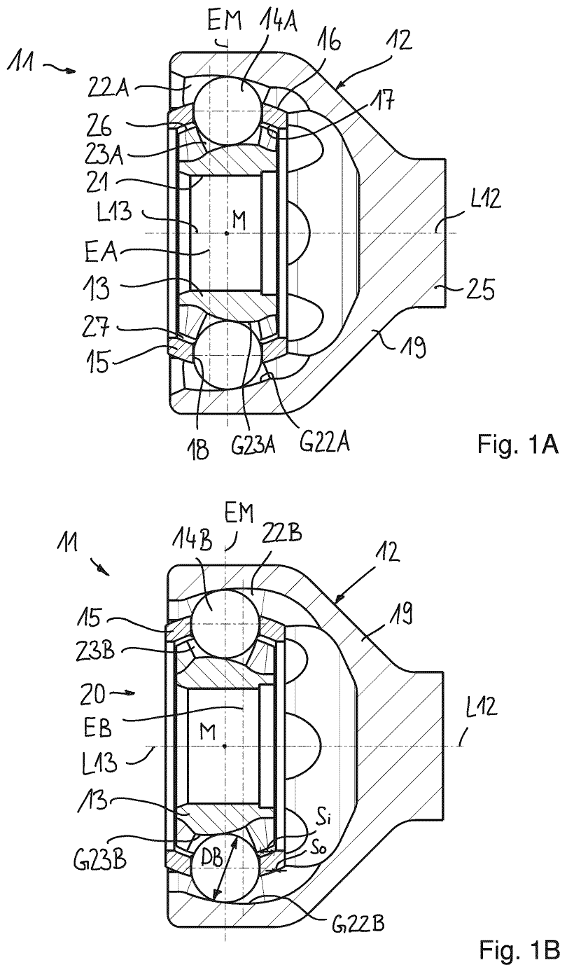

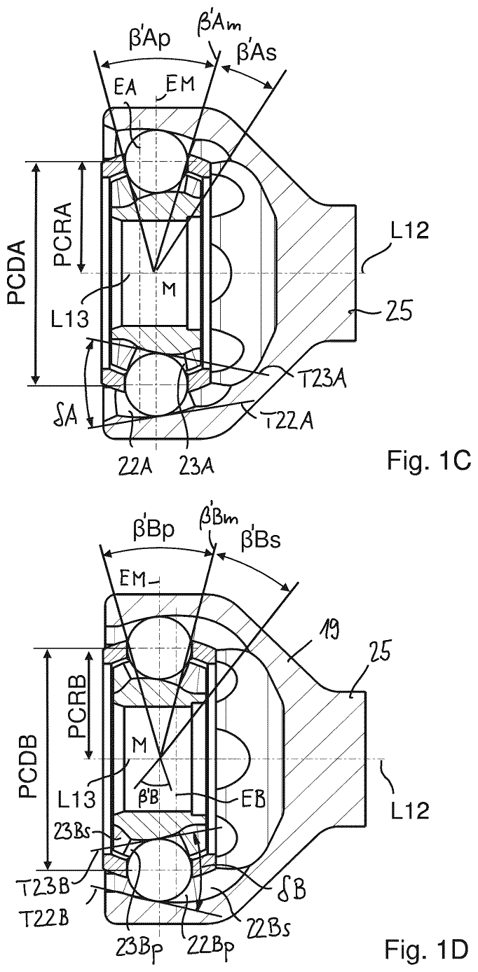

FIGS. 1A to 6C, which are described together below, show a countertrack joint 11. The countertrack joint 11 comprises an outer joint part 12, an inner joint part 13, a plurality of torque-transmitting balls 14A, 14B, and a ball cage 15. Play may be provided between a spherical outer face 16 of the ball cage 15 and a spherical inner face 24 of the outer joint part 12 in the installed state. A circumferential gap 27 is formed between a spherical inner face 17 of the ball cage 15 and a spherical outer face 26 of the inner joint part 13 in the installed state. In the present embodiment, the face centres M16 and M17 lie in a common joint centre plane EM, although in a modified embodiment it is also possible for the face centres M16 and M17 to each have an axial distance (offset) in opposite directions with respect to the joint centre plane EM. The balls 14A, 14B are received in circumferentially distributed cage windows 18 in the ball cage 15 in the joint centre plane EM. A longitudinal axis L12 is marked on the outer joint part 12 and a longitudinal axis L13 is marked on the inner joint part 13. The intersection of the longitudinal axes L12, L13 with the joint centre plane EM forms the joint centre point M.

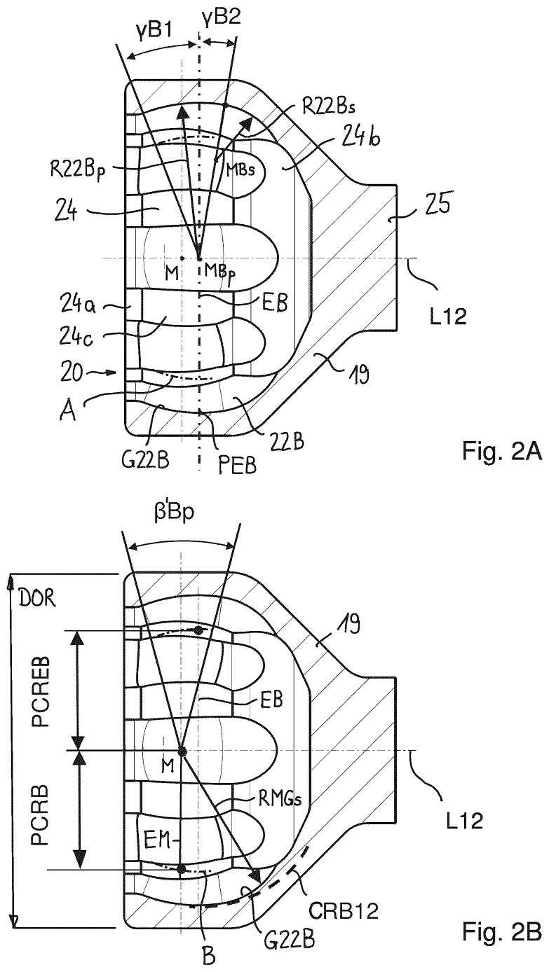

In the embodiment shown here, the inner face 24 of the outer joint part 12, the outer cage face 16, the inner cage face 17 and the outer face 27 of the inner joint part 13 are spherical in shape. Alternatively or additionally, one or more of the aforementioned faces may also have cylindrical, toroidal and/or conical sections. With regard to the inner face 24 of the outer part 12, an opening-side section 24a, a central section 24c and a base-side section 24b are shown in FIG. 2A. The base-side section 24b can form a support face against which the ball cage 15 can be axially supported with its outer face 16 when a drive shaft is inserted into the inner joint part 13.

The outer joint part 12 has a base 19, which can, for example, merge into a connecting journal 25, and an opening 20. The inner joint part 13 has an opening 21, into which the journal of a drive shaft 30 can be inserted in a rotationally fixed manner in order to transmit a torque. In the present disclosure, the position of the base 19 denotes the axial direction “towards the connecting side”, and the position of the opening 20 denotes the axial direction “towards the opening side”. These terms are also used in relation to the inner joint part 13, wherein the actual connection of a shaft to the inner joint part is not taken into account.

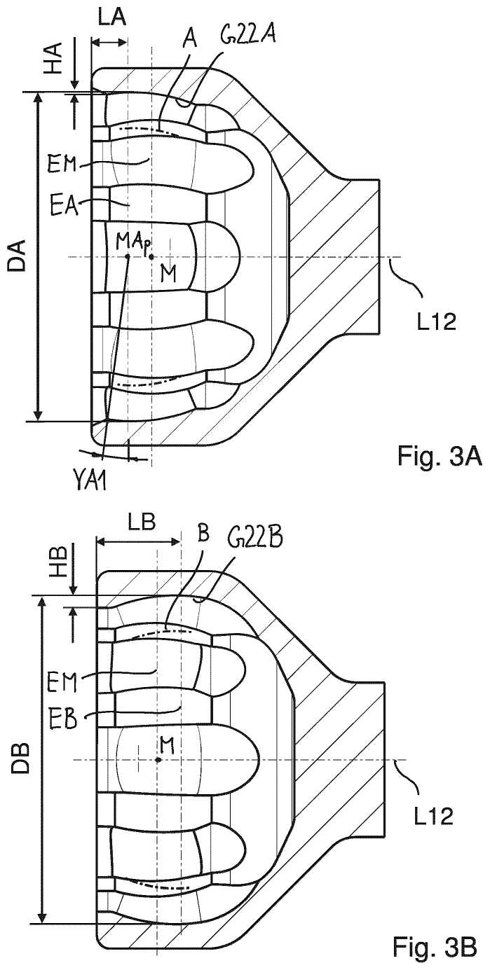

Alternating first pairs of tracks 22A, 23A with torque-transmitting first balls 14A and second pairs of tracks 22B, 23B with torque-transmitting second balls 14B are provided around the circumference. The first pairs of tracks 22A, 23A are shown in FIG. 1A, the second pairs of tracks 22B, 22B are shown in FIG. 1B. The first balls 14A are in contact with first outer ball tracks 22A in the outer joint part and first inner ball tracks 23A in the inner joint part. The centres of the first balls 14A define a first centre line A when moving along the outer and inner first ball tracks 22A, 23A, while the centres of the second balls 14B define a second centre line B when moving along the outer and inner second ball tracks 22B, 23B. The centre lines A, B are shown in FIGS. 3A and 3B. Furthermore, the outer and inner first ball tracks 22A, 23A each have an outer and inner first track baseline G22A, G23A, and the outer and inner second ball tracks 22B, 23B each have an outer and inner second track baseline G22B, G23B.

With the outer joint part 12 and inner joint part 13 aligned coaxially, the tangents T22A, T23A to the balls 14A form an opening angle SA at the contact points with the first tracks 22A, 23A, which opens towards the opening side. The second balls 14B are guided in outer ball tracks 22B in the outer joint part 12 and inner ball tracks 23B in the inner joint part 13. The balls 14B are shown with contact in the track base of the ball tracks, which does not necessarily have to be. In the aligned position shown, the tangents T22B, T23B to the second balls 14B form a second opening angle 8B at the contact points with the second tracks 22B, 23B, which opens towards the connection side. With a modified track shape of the countertrack joint, the opening angles orientated in opposite axial directions can also be provided in a slightly angled position of the joint of up to 2° in particular.

The number of torque-transmitting balls 14A, 14B and/or outer and inner ball tracks 22A, 22B; 23A, 23B is eight in the present case. However, modified embodiments with other numbers of balls, respectively pairs of tracks divisible by two, such as 6 or 10, are also possible. Respectively two first pairs of tracks 22A, 23A of the outer joint part 12 and inner joint part 13 are diametrically opposite each other, and two second pairs of tracks 22B, 23B are diametrically opposite each other.

The centre lines of the first and second pairs of tracks each lie in a radial plane through the joint without being restricted to this; the pairs of tracks can also run slightly helically around the respective longitudinal axis. Respectively one ball 14A, 14B is accommodated in a cage window 18 in the ball cage 15. The radial planes respectively have the same angular distance from each other.

In the following, the special features of the countertrack joint 11, which may be the configuration of the second ball tracks 22B of the outer joint part 12 and the configuration of the second ball tracks 23B of the inner joint part 13, are described in greater detail. The following definitions apply in connection with the present disclosure:

The joint articulation angle β defines the angle that is included between the longitudinal axis L12 of the outer joint part 12 and the longitudinal axis L13 of the inner joint part 13. The joint articulation angle β is zero when the joint is aligned.

The track articulation angle β′ defines the angle that a radius from the joint centre point M to the ball centre includes with the joint centre plane EM. The track articulation angle β′ is always half of the joint articulation angle β (β′=β/2) in every angular position of the joint.

The track section angle γ of a circular arc-shaped track section defines the angle over which the circular arc-shaped track section extends with a constant radius around the associated radius centre.

The opening angle δ defines the angle that is enclosed by tangents T to the balls at the contact points with the first ball tracks and/or the second ball tracks when the joint is aligned.

The control angle δ/2 defines the angle that a tangent applied to the respective ball centre line at the centre of the ball when the joint is aligned includes with the associated longitudinal axis L of the outer or inner joint part, respectively. The control angle δ/2 is equal to half the opening angle δ.

The centre plane EM is defined by the ball centres of the torque-transmitting balls 14A, 14B.

The first pitch circle diameter PCDA defines the diameter formed by the centres of the first balls 14A when the joint is aligned. The first pitch circle radius PCRA is obtained analogously as the radius of the first balls to the centre point.

The second pitch circle diameter PCDB defines the diameter formed by the centres of the second balls 14B when the joint is aligned. The second pitch circle radius PCRB is obtained analogously as the radius of the second balls to the centre point.

The pitch circle diameter PCDS defines the diameter of the insertion opening of the inner joint part 13, which may be by tooth root lines of the insertion opening.

The countertrack joint 2 is designed so that the inner joint part 13 can be angled relative to the outer joint part 12 over a primary joint articulation angle range Bp and an adjoining secondary joint articulation angle range Bs. The primary joint articulation angle range defines the articulation angle range within which the first and second balls 14A, 14B respectively move along during operation of the joint. In this respect, the primary joint articulation angle range Bp can also be referred to as the operating articulation angle. The maximum primary joint articulation angle is defined as the articulation angle at which all balls 14A, 14B are still just participating in the torque transmission between the outer joint part 12 and the inner joint part 13 before a first and/or second ball travelling on the opening side emerges from the associated track pair on the opening side. When the joint is angled within the operating articulation angle range βp, the first balls 14A move accordingly within the first track articulation angle ranges β′Ap, a maximum primary track articulation angle on the base side of the first outer ball tracks 22A being indicated β′Am. During operation, the second balls 14B move within the second track articulation angle ranges β′βp, a base-side maximum primary track articulation angle of the second outer ball tracks 22B being indicated β′Bm.

The primary joint articulation angle range βp may be less than +30°, for example±25°. Starting from the extended state, the inner joint part can therefore be angled by up to ±30° or less relative to the outer joint part during operation. During operation, the second balls 14B move within the primary track articulation angle range β′βp along the primary track section 22Bp of the outer joint part 12 up to the maximum primary track articulation angle β′Bm. The maximum primary track articulation angle β′Bm is less than +20°, which may be less than ±15° around the joint centre plane EM, for example±12.5°.

The primary track articulation angle β′βp of the second outer ball tracks 22B is followed by the secondary track articulation angle range β′Bs in the direction of the joint base 19. The first or second balls 14A, 14B only move into the secondary track articulation angle range when a diametrically opposite ball is mounted. In this respect, the secondary joint articulation angle range Bs includes the mounting articulation angle.

The track baselines G22A of the first ball tracks 22A of the outer joint part 12 have a largest radial first distance from the longitudinal axis L12 within the track articulation angle β′Ap in a first offset plane EA parallel to the joint centre plane EM. The track baselines G22B of the second ball tracks 22B have a maximum radial second distance from the longitudinal axis L12 within the track articulation angle β′βp in a second offset plane EB parallel to the joint centre plane EM. An offset plane intersection point PEB is defined between the base-side second offset plane EB and the second outer track baseline G22B, which is shown in FIG. 2A.

A reference arc CRB12 of the second outer ball track 22B is defined by the track radius R22Bp, which forms the second outer track baseline G22B in the second offset plane EB. It is provided that the second outer track baseline G22B runs radially within the second outer reference arc CRB12 in the direction of the joint base 19 when the joint is angled at the latest from a track articulation angle β′B of +20°, for example starting from ±15°. In FIG. 2B, a base line radius RMGs is drawn between the joint centre M and the track baseline G22B within the secondary track section 22Bs. The second ball tracks 22B, 23B are designed such that the baseline radius RMGs, at least at a joint articulation angle β of between ±40° to ±50° corresponding to a track articulation angle of ±20° to ±25°, which may be smaller than 1.45 times the pitch circle radius PCRB of the second balls 14B when the joint is aligned and/or smaller than 1.4 times the pitch circle radius PCREB of the second balls 14B in the offset plane EB.

As can be seen in particular in FIG. 2A, the track baselines G22B of the second outer ball tracks 22B each have a primary curvature R22Bp in the primary track section 22Bp and a secondary curvature R22Bs in the secondary track section 22Bs. The secondary curvature R22Bs is smaller than the primary curvature R22Bp, so that the ball tracks 22B pull radially inwards faster on the base side. This means that the outer joint part 12 can be made axially shorter in these circumferential areas. The curvature of the second outer track baseline G22B can be formed in the primary track section by a circular arc with a primary radius R22Bp around a primary centre point MBp. In the secondary track section, the track baseline G22B can be formed by a circular arc with a secondary radius R22Bs around a secondary centre point MBs. The secondary radius R22Bs is smaller than the primary radius R22Bp. The secondary centre point MBs has a radial offset relative to the longitudinal axis L12 of the outer joint part 12 in the direction of the ball track 22B and an axial offset relative to the joint centre plane EM in the direction towards the joint base 19 and can, for example, be located in the second offset plane EB.

Starting from the second offset plane EB, the primary track section 22Bp of the second ball tracks 22B of the outer joint part 12 has an opening-side primary track section between the second offset plane EB and the opening-side end. This opening-side primary track section may extend over an opening-side track section angle γBp1 of less than 23° around the track section centre point MBp. A base-side primary track section is formed between the second offset plane EB and the base-side end of the primary track section, which may extend over a base-side track section angle γBp2 of less than 12° around the track section centre point MBp.

Further details of the outer joint part 12 are shown in FIGS. 3A and 3B, which are also collectively referred to as FIG. 3. It can be seen that the first outer ball tracks 22A form a first undercut HA towards the opening side 20, and the second outer ball tracks 22B form a second undercut HB towards the opening side 20. The first undercut HA of the first ball tracks 22A opening towards the opening side may be smaller than the second undercut HB of the second ball tracks 22B opening towards the connection side. For example, the second outer undercut HB may be greater than five times the first outer undercut HA.

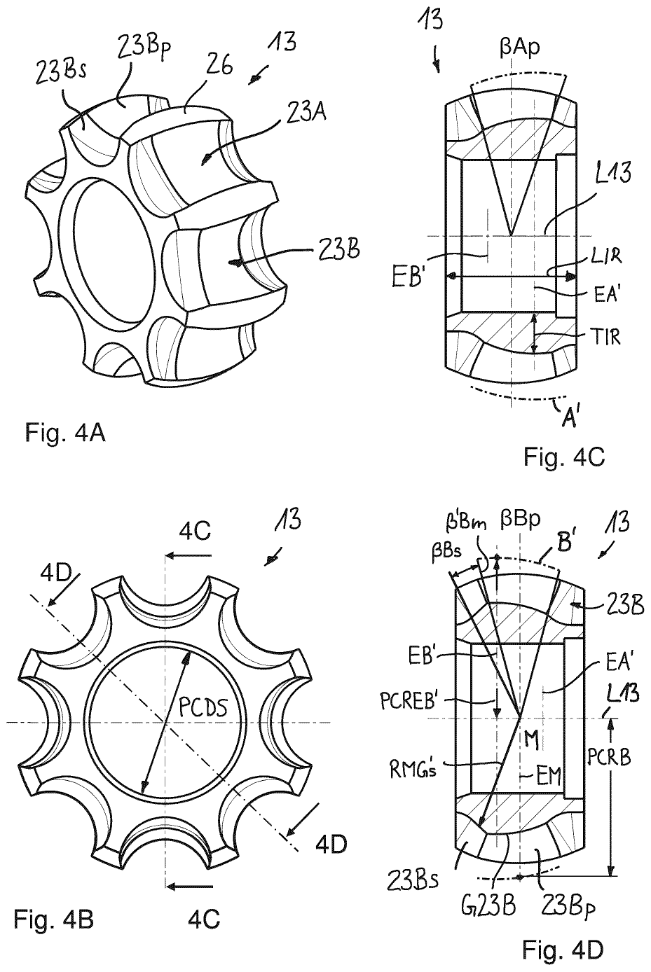

FIGS. 4A to 4D, collectively also referred to as FIG. 4, show the inner joint part 13 of the countertrack joint 11. The first ball track 23A, which widens towards the opening side, defines the first centre line A′, while the second ball tracks 23B, which open towards the connection side, define the second centre line B′ of the inner joint part 13.

The first ball centre line A′ of the inner joint part 13 is complementary to the first ball centre line A of the outer joint part 12. This means that the ball centre line A′ of the inner joint part 13 is mirror-symmetrical to the ball centre line A of the outer joint part 12 in relation to the joint centre plane EM. Accordingly, the second ball centre line B′ of the inner joint part 13 is complementary to the second ball centre line B of the outer joint part 12, i.e. the second ball centre line B′ of the inner joint part 13 is mirror-symmetrical to the ball centre line B of the outer joint part 12 with respect to the joint centre plane EM. With regard to the course of the first and second ball centre lines A′, B′ of the inner joint part 13, reference is thus also made to the description in connection with the outer joint part 12. FIG. 4D shows a first offset plane EA′ on the inner joint part 13, which corresponds to and/or overlaps with the second offset plane EB of the outer joint part 12 when the joint is in the assembled, aligned state. The second offset plane EB′ of the inner joint part 13 corresponds to the first offset plane EA of the outer joint part 12 when the joint is assembled and aligned.

The second ball tracks 23B of the inner joint part 13 have a primary track section 23Bp and, adjoining it on the opening side, a secondary track section 23Bs. The second balls 14B move along the primary track section 23Bp of the inner part during angular movements within the primary articulation angle range up to the maximum primary articulation angle. For larger angular movements, i.e. starting from the secondary articulation angle range, the second balls 14B move within the secondary track section 23Bs. It can be seen in particular in FIG. 4D that the second inner ball tracks 23B have a second inner track baseline G23B, which is convex in the primary track section 23Bp in longitudinal section through the track base and is concavely curved and/or straight at least in sections in the secondary track section 23Bs. In this case, the secondary track section 23Bs forms a radially set-back recess in the direction of the opening side.

An inner baseline radius RMGs' from the joint centre point M to the track baseline G23B within the inner secondary track section 23Bs can be defined on the inner joint part 13. The inner baseline radius RMGs' can be smaller than 1.45 times the pitch circle radius PCRB of the second balls 14B when the joint is aligned and/or smaller than 1.5 times the pitch circle radius PCREB′ in the second offset plane EB′ of the inner joint part 13, at least at a joint articulation angle β of between ±40° and ±50° corresponding to a track articulation angle of ±20° to ±25°.

According to a further embodiment, the primary joint articulation angle βp is less than 0.5 times and/or greater than 0.35 times the smallest second mounting articulation angle βBs at which the second balls are insertable into the second pairs of tracks. The same ratios also apply for a cage operating articulation angle relative to the cage mounting articulation angle. The smallest second joint mounting articulation angle αBs can be greater than ±50° or ±60°, for example.

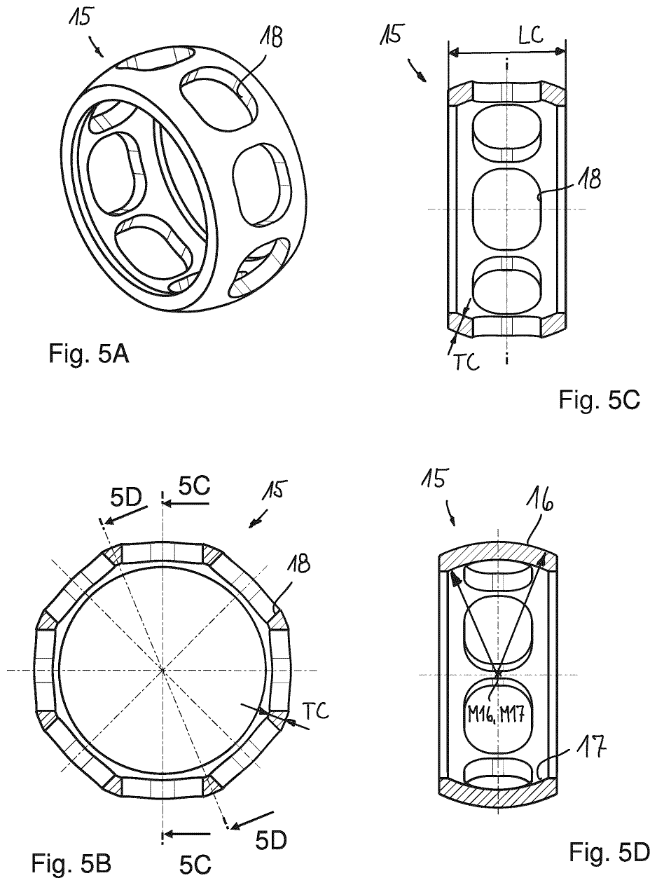

The cage 15 is shown in detail in FIGS. 5A to 5D. The circumferentially distributed cage windows 18, the spherical outer face 16 and the spherical inner face 17 are visible, which are arranged coaxially to one another in the present case. The outer cage face 16 of the ball cage 15 and the inner face 24 of the outer joint part 12 on the one hand, and the inner cage face 17 of the ball cage and the outer face 26 of the inner joint part 13 on the other hand, can be produced in particular such that in the assembled and aligned state of the countertrack joint 11, the total outer axial play So between the ball cage 15 and the outer joint part 12 and the total inner axial play Si between the ball cage 15 and the inner joint part 13 are of different sizes. In the present case, the outer total axial play is smaller than the inner total axial play. Furthermore, the spherical faces 24, 16, 17, 26 of the joint parts 12, 13, 15 can be designed such that in the assembled state of the joint 11, in which the equator of the spherical face 26 of the outer joint part 12 and the equator of the outer spherical cage face 16 lie in one plane, and the equator of the spherical cage inner face 17 and the spherical face 26 of the inner joint part 13 lie in one plane, the outer axial and radial play is smaller than the inner axial and radial play.

The spherical outer face and inner face 16, 17 of the ball cage 15 can be soft-finished and then hardened. The soft-machining of the faces 16, 17 can be carried out by machining, for example by turning or grinding, and/or without machining, for example by forming. The webs of the cage windows 18 that guide the balls 14A, 14B laterally may be hard-machined, which may be ground, after hardening.

A countertrack joint 2 with eight balls 14A, 14B as shown in FIGS. 1 to 6 with an operating articulation angle of, for example, between ±20° and ±30° has a compact size which may be if the following ratios and/or ranges for respective design values are satisfied:

$$3. 4 < PCD / DB < 3.7$$

$$1.05 < LIR / DB < 1.35$$

$$0.3 < TIR / DB < 0. 5$$

$$1.6 < PCDS / DB < 1.8$$

$$2.9 < DOR / PCDS < 3.2$$

$$0.24 < TC / DB < 0. 28$$

$$1.6 < LC / DB < 1.9$$

$$1.15 < RMGs / PCRB < 1.4$$

$$2. < β Bs / β p < 2.8$$

$${18}^{∘} < γ B 1 < 2 {3}^{∘}$$

$${2}^{∘} < γ B 2 < {12}^{∘}$$

$${2}^{∘} < γ A 1 < {10}^{∘}$$

$$5 < HB / HA < 10$$

The named values have the following meaning:
βBs: Joint mounting angle for a second pair of tracks
βp: Joint operating articulation angle
DB: Ball diameter
DOR: Outer diameter of outer joint part
HA: Undercut of first ball track (outer joint part)
HB: Undercut of second ball track (outer joint part)
LC: Cage length
LIR: Axial length of the inner joint part
PCD: Pitch circle diameter balls
PCDS: Pitch circle diameter of shaft splines
PCRB: Pitch circle radius of the balls of track B
RMGs: Radius from the joint centre to the track base of the secondary track section of track B
TC: Cage thickness
TIR: Thickness of the inner joint part

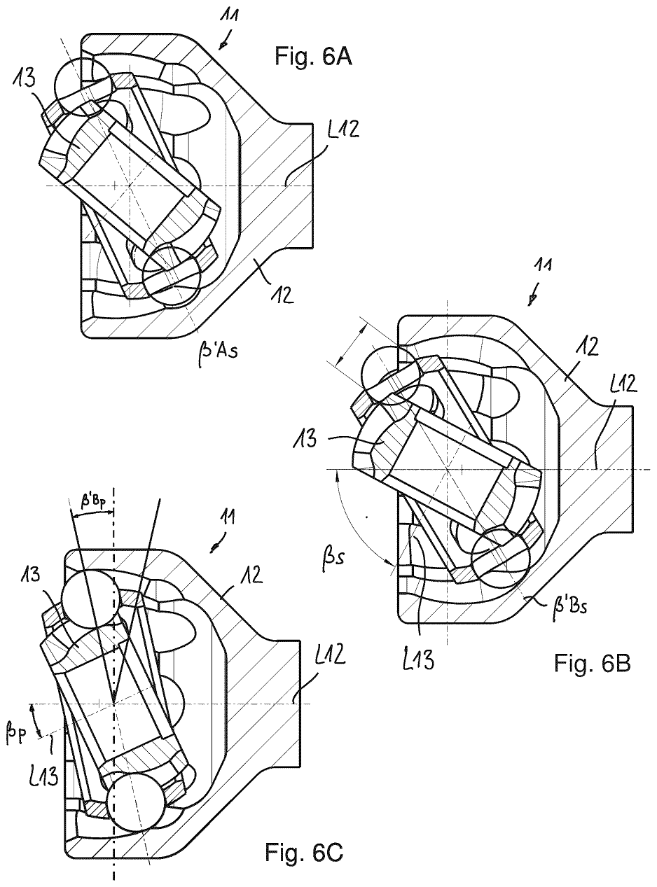

FIGS. 6A and 6B show the countertrack joint in two assembly states of the balls. For this purpose, the inner joint part 13 is over-articulated relative to the outer joint part to an assembly articulation angle βs. First, the second balls 14B are inserted into the second ball tracks 22B, 23B, as shown in FIG. 6B. Then the first balls 14A are inserted into the first ball tracks 22A, 23A, as shown in FIG. 6A. In FIG. 6C, the countertrack joint 2 is shown at an operating articulation angle βp, which corresponds to a track articulation angle of βp′.

Several manufacturing processes are possible. The outer joint part 12 and the inner joint part 13 can be produced in the following sequence: pre-forging of a blank, hardening of the forged preform and mechanical finishing of the hardened preform, for example by turning and/or grinding. Alternatively, at least one of the outer joint part 12 and the inner joint part 13 can be finish-machined before hardening, for example by forming, wherein no further shaping machining takes place after hardening. According to a further possibility, both joint parts 12, 13 can also be hardened and finished after hardening, for example by turning and/or grinding.

1. A countertrack joint comprising:
an outer joint part with a longitudinal axis, a joint base, defining a connecting side, and an opening defining an opening side, and first outer ball tracks and second outer ball tracks, which are arranged circumferentially distributed in an inner face of the outer joint part and which are at least partially curved in a longitudinal section;
an inner joint part with a longitudinal axis, and first inner ball tracks and second inner ball tracks-which are arranged circumferentially distributed in an outer face of the inner joint part and which are at least partially curved in a longitudinal section;
wherein the first outer ball tracks and the first inner ball tracks form first pairs of tracks with one another, which widen towards the opening side of the outer joint part,
and wherein the second outer ball tracks and the second inner ball tracks form second pairs of tracks with one another, which widen towards the connecting side, wherein the second outer ball tracks have a second outer track baseline and, adjoining thereto, a second outer primary track section and a second outer secondary track section,
a first ball in each first pair of tracks and a second ball in each second pair of tracks,
a ball cage which is arranged between the outer joint part and the inner joint part and which has a cage inner face, a cage outer face and circumferentially distributed cage windows, which each receive at least one of the balls, wherein the balls at coaxially aligned longitudinal axes of the inner joint part and the outer joint part are held by the ball cage on a joint centre plane,
wherein the inner joint part is angularly movable relative to the outer joint part, wherein the second balls-move within a primary track articulation angle range-up to a maximum primary track articulation angle of ±20° around the joint centre plane along the second outer primary track section, wherein a maximum primary joint articulation angle is defined as the joint articulation angle at which all balls are still just involved in the torque transmission between the outer joint part and the inner joint part before a ball travelling towards the opening side exits the associated pair of tracks on the opening side,
wherein the second outer track baseline within the second outer primary track section has a greatest radial distance from the second longitudinal axis in a second offset plane parallel to the joint centre plane, wherein a second offset plane intersection point is defined between the second offset plane and the second outer track baseline,
wherein a second outer radius-forming the second outer track baseline in the second offset plane defines a second outer reference arc,
wherein the second outer track baseline, from the joint centre plane towards the joint base, runs at latest from a track articulation angle of ±20° radially within the second outer reference arc.

2. The countertrack joint according to claim 1, wherein the second outer track baseline, in the direction of the joint base, in a secondary track articulation angle range adjoining the primary track articulation angle range extends at least up to ±25° radially within the second outer reference arc.

3. The countertrack joint according to claim 1,
wherein the second outer track baseline has a primary curvature in the primary track section and a secondary curvature in the secondary track section, the secondary curvature being smaller than the primary curvature.

4. The countertrack joint according to claim 1,
wherein the second outer track baseline in the primary track section is formed by a circular arc with a primary radius around a primary centre point, and in the secondary track section is formed by a circular arc with a secondary radius around a secondary centre point, the secondary radius being smaller than the primary radius, and
wherein in the outer joint part the secondary centre point has a radial offset relative to the longitudinal axis of the outer joint part in the direction of the second ball track and an axial offset relative to the joint centre plane in the direction of the joint base.

5. The countertrack joint according to claim 1,
wherein the second outer ball tracks between the second offset plane and an opening-side primary section end define an opening-side primary track section which extends over an opening-side track section angle of more than 18° and less than 23° around the track section centre point.

6. The countertrack joint according to claim 1,
wherein the second outer ball tracks between the second offset plane and the base-side end of the primary track section define a base-side primary track section which extends over a base-side track section angle of more than 2° and less than 12° around the track section centre point.

7. The countertrack joint according to claim 1,
wherein an outer secondary baseline radius from the joint centre to the track baseline within the secondary track section of the second outer ball track, at least at a secondary joint articulation angle of ±40° to ±50°, is less than 1.45 times the pitch circle radius of the second balls-when the joint is aligned.

8. The countertrack joint according to claim 1,
wherein the second ball tracks of the inner joint part have a second inner primary track section and, adjoining thereto on the opening side, a second inner secondary track section,
wherein the second balls, for angular movements within the primary track articulation angle range up to the maximum primary articulation angle move along the second inner primary track section, and for larger angular movements within the secondary track articulation angle range move within the second inner secondary track portion,
wherein the second inner ball tracks have a second inner track baseline which in the second inner primary track section is convexly curved, and in the second inner secondary track section is concavely curved or straight, at least in sections.

9. The countertrack joint according to claim 8,
wherein an inner secondary baseline radius from the joint centre to the second inner track baseline-within the second inner secondary track section, at least at a secondary joint articulation angle of ±40° to ±50°, is smaller than 1.45 times the pitch circle radius of the second balls when the joint is aligned.

10. The countertrack joint according to claim 1,
wherein the first outer ball tracks between the first offset plane and an opening-side end of the primary track section define an opening-side primary track section which extends over an opening-side track section angle of more than 2° and less than 10° around the track section centre point.

11. The countertrack joint according to claim 1,
wherein the primary joint articulation angle is less than 0.5 times a smallest second joint mounting articulation angle at which the second balls are insertable into the second pairs of tracks, wherein the smallest second joint mounting articulation angle is greater than 60°.

12. The countertrack joint according to claim 1,
wherein the first outer ball tracks have a first outer undercut on the opening side, and the second outer ball tracks have a second outer undercut on the opening side, the second outer undercut being larger than the first outer five times and smaller than 10 times the first outer undercut.

13. The countertrack joint according to claim 1,
wherein the first and second outer ball tracks form an outer ball track group, and the first and second inner ball tracks form an inner ball track group, at least one of the outer ball track group and the inner ball track group being finish-machined prior to hardening, which means that it is mechanically unmachined after hardening.

14. The countertrack joint according to claim 13,
wherein one of the outer ball track group and the inner ball track group is hardened and is finish-machined after hardening.

15. The countertrack joint according to claim 1,
wherein the first outer ball tracks and the second outer ball tracks of the outer joint part are soft-machined and hardened, and
wherein that the first inner ball tracks and the second inner ball tracks of the inner joint part are hardened and hard-finished.
